(19) United States
(12) Patent Application Publication
(10) Pub. No.: US 2013/0260197 A1
(43) Pub. Date: Oct. 3, 2013

(54) BATTERY ARRAY, BATTERY SEPARATOR, AND VEHICLE EQUIPPED WITH BATTERY ARRAY

(71) Applicants: Wataru Okada, Kobe-shi (JP); Shinsuke Nakamura, Kobe-shi (JP); Kentaro Uemura, Kasai-shi (JP); Akinobu Wakabayashi, Kobe-shi (JP)

(72) Inventors: Wataru Okada, Kobe-shi (JP); Shinsuke Nakamura, Kobe-shi (JP); Kentaro Uemura, Kasai-shi (JP); Akinobu Wakabayashi, Kobe-shi (JP)

(21) Appl. No.: 13/885,566

(22) PCT Filed: Nov. 11, 2011
(86) PCT No.: PCT/JP11/76106

§ 371 Date: Jun. 20, 2013

(30) Foreign Application Priority Data
Nov. 18, 2010 (JP) 2010-257977

(51) Int. Cl. H01M 2/10

(52) U.S. Cl. CPC H01M 2/1083
USPC 429/90; 429/99; 429/100

(57) ABSTRACT

The battery array is provided with a plurality of battery cells having a rectangular outline, insulating separators intervening between adjacent battery cells, a pair of endplates disposed at the ends of the battery cells stacked alternately with intervening separators, and binding bars that bind the endplates together. Partition plates, which are the parts of the separators sandwiched between adjacent battery cells, have thin regions established along regions opposite the upper ends of the battery cells, and the thin regions are formed thinner than partition plate regions opposite the center sections of the battery cells.

### BACKGROUND OF THE INVENTION

1. Field of the Invention

The present invention relates to a battery array and battery separator used primarily in apparatus such as a power source that powers a motor to drive a vehicle such as a hybrid vehicle or electric vehicle, and to the vehicle equipped with the battery array

2. Description of the Related Art

A vehicle (automobile) such as an electric vehicle (EV, electric automobile) driven by an electric motor, or a hybrid vehicle (hybrid car, hybrid electric vehicle, HEV) driven by both an electric motor and an engine carries on-board a power source apparatus, which has battery cells housed in an external casing. To achieve an output capable of driving the vehicle with the motor, the power source apparatus has many battery cells connected in series to increase the output voltage. For example, battery cells with rectangular external cases are stacked to form a battery array, and a power source apparatus is configured by connecting a plurality of those battery arrays (e.g. refer to Japanese Laid-Open Patent Publication Nos. 2008-282582 and 2010-110833).

Each battery cell has positive and negative electrode terminals protruding from its upper surface. Each electrode terminal is attached to the battery cell sealing plate. A plurality of battery cells is stacked together with intervening insulating separators, and endplates are disposed at the ends of the stack to form a battery array. In addition, the endplates are fastened together with metal binding bars to maintain the battery array in a stacked configuration. When the stack is fastened together via binding bars, sufficient strength is required to stably hold the battery cells over a long period. In particular, since a battery array used in an automotive application is subject to vibration and mechanical shock, robust binding is a necessity.

However, when rectangular battery cells are squeezed together from both sides, stress is not applied uniformly, but rather is concentrated at the outer edges of the battery cells. As a result, this stress concentration can compress the outer edge regions of a battery cell and crush the external case or damage the external case-to-sealing plate weld region. Further, since the external case of a battery cell has its upper opening closed-off by laser-welding the sealing plate to the external case, outside dimensions in the area of the upper opening are slightly enlarged due to the laser-weld. In addition, the metal external case of a battery cell is formed in a box-shape with an open upper end by deep-drawing sheet metal, and the slope of the sides necessary for punch extraction makes the perimeter of the upper end larger than the perimeter at the bottom. As a result, when battery cells are stacked and sandwiched between the endplates, there is a tendency for stress to concentrate at the upper edges of the external cases. Consequently, there is a possibility that a laser-welded sealing plate could come off and electrolyte solution could leak out.

The present invention was developed considering the background described above. Thus, it is a primary object of the present invention to provide a battery array, battery separator, and vehicle equipped with the battery array that alleviates stress concentration when battery cells are stacked together, prevents battery cell deformation and damage, and improves post-assembly reliability.

### SUMMARY OF THE INVENTION

To achieve the object described above, the battery array for the first aspect of the present invention is provided with a plurality of battery cells having a rectangular outline, insulating separators intervening between the battery cells, a pair of endplates at the ends of the battery cells stacked alternately with intervening separators, and binding bars that bind the endplates together. Each separator has a partition plate that is sandwiched between adjacent battery cells, and a thin region, which is formed thinner than the partition plate region opposite the center sections of the battery cells, is established along the partition plate opposite the upper ends of the battery cells.

In the battery array described above, each battery cell is disposed between the partition plates of adjacent separators and a plurality of battery cells and separators are stacked together. When the stack of battery cells and separators is sandwiched between endplates, stress concentration at the upper ends of the battery cells can be prevented. This is because when the separator partition plates are sandwiched between battery cells and pressure is applied by the endplates, thin regions established on the partition plates prevent excessive pressure application on the battery cell surfaces and alleviate stress concentration at the upper ends of the battery cells. This can prevent deformation and damage at the edges of the upper ends of the battery cells.

A rectangular battery cell has an opening established at the upper end of its external case, and a sealing plate is laser-welded in the opening to hermetically seal the battery cell closed. Consequently, if a battery cell is sandwiched between separators having a uniform thickness in the part contacting the battery cell (as in prior art battery arrays), the upper end of the battery cell will locally contact the separators and stress will be concentrated in that region. This has the detrimental effect that the battery cell can become deformed or damaged. In particular, the upper end of the battery cell has a bulkhead-like sealing plate inside and will not flexibly deform when compression forces are applied. Accordingly, when significant pressure is applied to the upper end region by the separators, pressure is concentrated in that region and does not become distributed across other sections of the battery cell. As a result, extremely high, locally applied stress develops and becomes a cause of battery cell damage.

In the battery array described above, since thin regions are established at the upper ends of the separator partition plates, the upper ends of the battery cells are not strongly pressed upon (in the partition plate thin regions), and the battery array has the characteristic that battery cell deformation and damage can be effectively prevented.

In the battery array for the second aspect of the present invention, each separator can have thin regions established in the partition plate opposite the perimeters of the battery cells, and those thin regions are formed thinner than the partition plate region opposite the center sections of the battery cells. In this battery array, when each battery cell is disposed between adjacent separators and a plurality of battery cells and separators are stacked together sandwiched between endplates, stress concentration at the battery cell perimeters can be prevented. This is because the gap between adjacent separator partition plates is made wider in battery cell perimeter regions by the thin regions established in those parts of the partition plates. As a result, the battery array has the positive feature that when battery cells and separators are pressed together by the endplates, stress is not concentrated at battery cell perimeters and deformation or damage to the outer edges of the battery cells can be avoided. In particular, the center section of a battery cell is in planar regions of the external case that can deform flexibly with relative ease, and that section is not immediately damaged even if pressure forces are applied. This achieves the positive feature that the stack of battery cells can be reliably held together while protecting battery cell perimeter regions.

In the battery array for the third aspect of the present invention, boundaries between the thin regions and the center region of a partition plate an be formed in step shapes. This allows the thin regions established in the periphery to be easily distinguished.

In the battery array for the fourth aspect of the present invention, the thin regions can be tapered and gradually become thinner as the outer edges of the battery cells are approached. This has the positive feature that thin regions gradually become thinner towards battery cell outer edges and stress concentration at the outer edges is mitigated in degrees.

In the battery array for the fifth aspect of the present invention, the width (W) of the thin regions established on the partition plate of a separator can be made greater than or equal to 2 mm.

In the battery array for the sixth aspect of the present invention, the width (W) of the thin regions established on the partition plate of a separator can be made less than or equal to 30 mm.

In the battery array for the seventh aspect of the present invention, the difference between the average thickness in the thin regions of a partition plate and the thickness in regions opposite battery cell center sections can be made greater than or equal to 0.05 mm.

In the battery array for the eighth aspect of the present invention, the external case of each battery cell is covered by insulating heat-shrink tubing, and the heat-shrink tubing is heat-sealed together at the bottom of the battery cell. Each separator has bottom walls, which are flat plates protruding horizontally from the bottom end of the separator, and the bottom walls of adjacent separators have bottom openings established between the separators-to retain the heat-sealed sections of the heat-shrink tubing. When adjacent separators are aligned together, the heat-shrink tubing heat-sealed sections can be disposed in the bottom openings. In this battery array, heat-shrink tubing heat-sealed sections are positioned at the battery cell bottom surfaces, and those heat-sealed sections are guided into the bottom openings established in the bottom walls of the separators. As a result, when battery cells and separators are stacked together, heat-shrink tubing heat-sealed sections do not get caught between, and damaged by adjacent separators and do not cause wide gaps between the separators. Accordingly, a plurality of battery cells can be retained in the same parallel orientation and stacked neatly together.

In the battery array for the ninth aspect of the present invention, the top part of a separator can be provided with a sensor cavity to dispose a temperature sensor to detect battery cell temperature. By inserting a temperature sensor in the sensor cavity of a separator in this battery array, the temperature sensor can be accurately disposed in a specified location and can accurately detect battery cell temperature. In particular, since the temperature sensor can be disposed in a specified location without shifting position, long-term accurate battery cell temperature detection can be achieved even in an application such as a vehicle power source apparatus that is subject to vibration.

In the battery array for the tenth aspect of the present invention, the sensor cavity can be made up of an insertion section that opens at an oblique angle with respect to the upper edge of the separator, and a retaining section-connected with the insertion section and extending in a horizontal direction. A temperature sensor can be inserted from the insertion section into the retaining section to dispose the sensing element in the retaining section. In this battery array, since the temperature sensor is inserted from the insertion section into the retaining section to dispose the sensing element in the retaining section, the sensing element can be accurately disposed in a specified position with respect to the battery cell. This is because the sensing element is held in the retaining section by inserting the temperature sensor from the insertion section into the horizontally extending retaining section. Further, since the temperature sensor is introduced through a bend from an obliquely ramped direction to a direction extending horizontally, it cannot easily fall out of position once it has been inserted and has the positive feature that it can be held reliably in position.

The battery separator for the eleventh aspect of the present invention is an insulating separator to intervene between and insulate adjacent battery cells stacked together in a battery array with a plurality of battery cells having a rectangular outline. Further, a thin region, which is formed thinner than the region opposite the center sections of the battery cells, is established opposite the upper ends of the battery cells. When this battery separator is inserted between battery cells, a plurality of battery cells and separators are stacked together, and the stack is sandwiched between endplates at the ends of the stack, stress concentration at the upper ends of the battery cells can be prevented. This is because thin regions established along separator regions opposite the upper ends of the battery cells can prevent strong pressure forces from being applied to those battery cell surfaces and prevent stress concentration at the upper ends of the battery cells. By virtue of the thin regions, this battery separator does not apply high pressure to the upper ends of the battery cells and can effectively prevent battery cell deformation and damage.

The battery separator for the twelfth aspect of the present invention can be provided with thin regions established opposite the perimeters of the battery cells, and those thin regions are formed thinner than the region opposite the center sections of the battery cells. When this battery separator is inserted between battery cells, a plurality of battery cells and separators are stacked together, and the stack is sandwiched between endplates at the ends of the stack, stress concentration at the battery cell perimeters can be prevented. This is because application of strong pressure forces to battery cell perimeters is prevented by the thin regions established in separator regions opposite the battery cell perimeters, and this can prevent stress concentration at the battery cell perimeters. As a result, this battery separator has the positive feature that when battery cells and separators are pressed together by the endplates, deformation or damage to the outer edges of the battery cells can be avoided. In particular, the center section of a battery cell is in external case planar regions that can deform flexibly with relative ease, and that section is not immediately damaged even if pressure forces are applied. This achieves the positive feature that the stack of battery cells can be reliably held together while protecting battery cell perimeter regions.

The vehicle for the thirteenth aspect of the present invention can be equipped with the battery array described above.

### BRIEF DESCRIPTION OF THE DRAWINGS

FIG. 1 is an oblique view of a battery array for an embodiment of the present invention.

FIG. 2 is an exploded oblique view of the battery array shown in FIG. 1.

FIG. 3 is an oblique view of the bottom of the battery array shown in FIG. 1.

FIG. 4 is an exploded oblique view showing the separator and battery cell stacking configuration.

FIG. 5 is an oblique view showing a battery cell enclosed in heat-shrink tubing.

FIG. 6 is an enlarged cross-section view showing the bottom region of a battery cell enclosed in heat-shrink tubing.

FIG. 7 is a cross-section view with enlarged insets showing the separator and battery cell stacking configuration.

FIG. 8 is a front view of a separator.

FIG. 9 is an enlarged cross-section view showing a temperature sensor inserted in a separator.

FIG. 10 is a cross-section view with enlarged insets showing another example of a separator.

FIG. 11 is a cross-section view with enlarged insets showing another example of a separator.

FIG. 12 is a block diagram showing a vehicle for an embodiment of the present invention that is a hybrid vehicle driven by a motor and an engine.

FIG. 13 is a block diagram showing a vehicle for another embodiment of the present invention that is an electric vehicle driven by a motor only.

### DESCRIPTION OF THE EMBODIMENT(S)

The following describes embodiments of the present invention based on the figures. However, the following embodiments are merely specific examples of a battery array, battery separator, and vehicle equipped with the battery array representative of the technology associated with the present invention, and the battery array, battery separator, and vehicle equipped with the battery array of the present invention is not limited to the embodiments described below. Further, components cited in the claims are in no way limited to the components indicated in the embodiments.

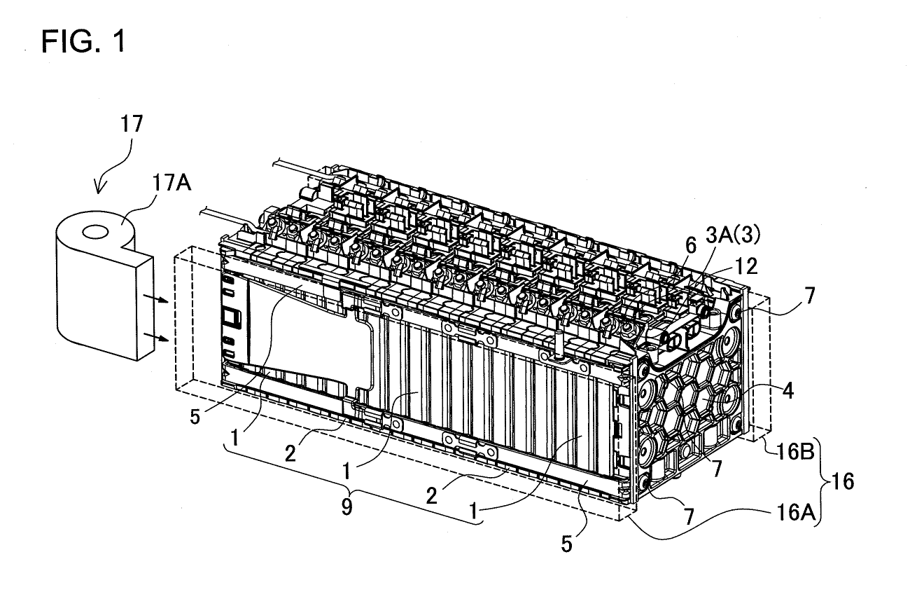

The battery array shown in FIG. 1 is optimally suited for a power source primarily in an electric powered vehicle such as a hybrid vehicle (hybrid car, hybrid electric vehicle, HEV) driven by both an electric motor and an engine or an electric vehicle (EV, electric automobile) driven by an electric motor only. However, the battery array can also be used in applications other than electric powered vehicle applications (such as in a hybrid vehicle or electric vehicle) that require high power output.

The battery array shown in FIGS. 1-3 is a plurality of battery cells 1 having rectangular outlines stacked with intervening separators 2 to form a battery block 9. Endplates 4 are disposed at both ends of the battery block 9.

The pair of endplates 4 is held together by binding bars 5 to retain the stack of separators 2 and battery cells 1 in a given state of compression. The endplates 4 are rectangular with outlines that have essentially the same shape and dimensions as the battery cells 1. The endplates 4 hold the battery array by sandwiching it between both ends. As shown in FIG. 1, the battery array has cooling gaps 13 established between the separators 2 and battery cells 1, and ventilating ducts 16 on both sides to forcibly ventilate the cooling gaps 13. In this battery array, cooling gas is forcibly introduced from the ventilating ducts 16 into the cooling gaps 13 to cool the battery cells 1. Heated gas can also be forcibly introduced from the ventilating ducts 16 into the cooling gaps 13 to warm the battery cells 1.

(Battery Cell 1)

Each battery cell 1 is a thin rectangular outline battery with a thickness that is narrower than its width. Battery cells 1 are sandwiched in parallel orientation between separators 2 to form a stack insulated by the separators 2.

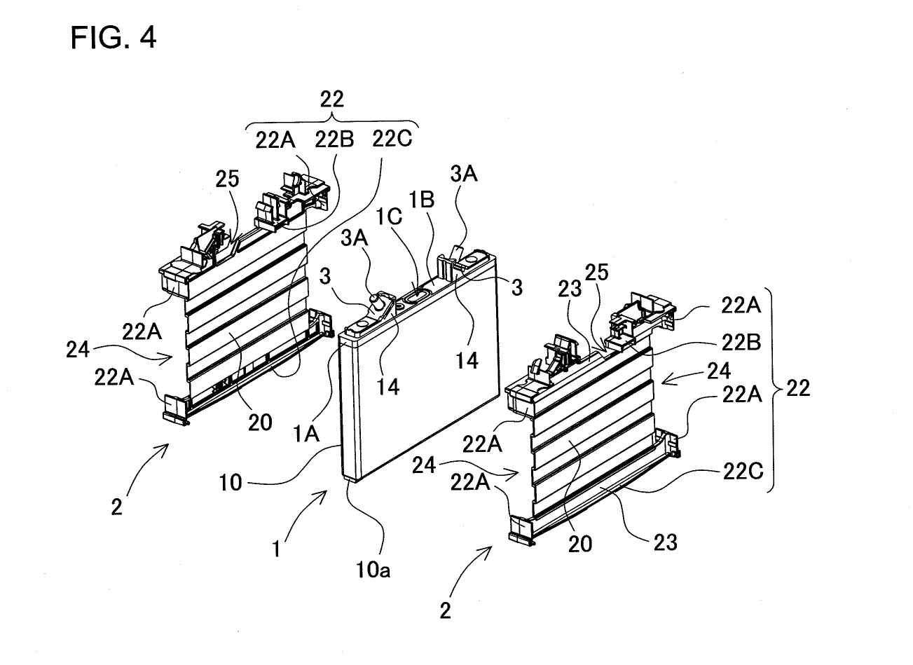

As shown in FIG. 4, each battery cell 1 has electrode terminals 3 fixed in a manner protruding from the end regions of the upper surface of the battery cell 1. The locations where the positive and negative electrode terminals 3 protrude from the top of a battery cell 1 are laterally symmetric. As a result, individual battery cells 1 can be flipped laterally during stacking, and adjacent positive and negative electrode terminals 3 can be directly connected or joined by metal bus-bars 6 to connect the battery cells 1 in series. A battery array with series-connected battery cells 1 can output a high voltage. However, the battery array can also be connected in series and parallel.

The battery cells 1 are lithium ion rechargeable batteries. However, the battery cells are not limited to lithium ion rechargeable batteries, and any batteries that can be charged, such as nickel hydride batteries, can also be used. A battery cell 1 has an electrode unit that is a stack of positive and negative electrode plates inserted in an external case 1A, and the external case 1A is filled with electrolyte solution and sealed in an air-tight manner. As shown in FIG. 4, the external case 1A is formed in the shape of a rectangular cylinder with a closed bottom, and the opening at the upper end is sealed closed in and air-tight manner by a sheet-metal sealing plate 1B. The external case 1A in manufactured by deep-drawing sheet-metal such as aluminum or aluminum alloy. An external case formed by the deep-drawing process has side-walls that taper outward towards the opening at the upper end. This is for the purpose of punch extraction in the deep-drawing process. Consequently, the outline of the external case 1A is slightly larger at the opening in the upper end than at the bottom. The sealing plate 1B is made from sheet-metal such as aluminum or aluminum alloy, which is the same material as that of the external case 1A. The sealing plate 1B has positive and negative electrode terminals 3 mounted in its end regions via terminal holders 14. The sealing plate 1B is inserted into the opening in the external case 1A, and the interface between the outside perimeter of the sealing plate 1B and the inside of the external case 1A is irradiated with laser light to laser-weld and attach the sealing plate 1B to the external case 1A in an air-tight manner.

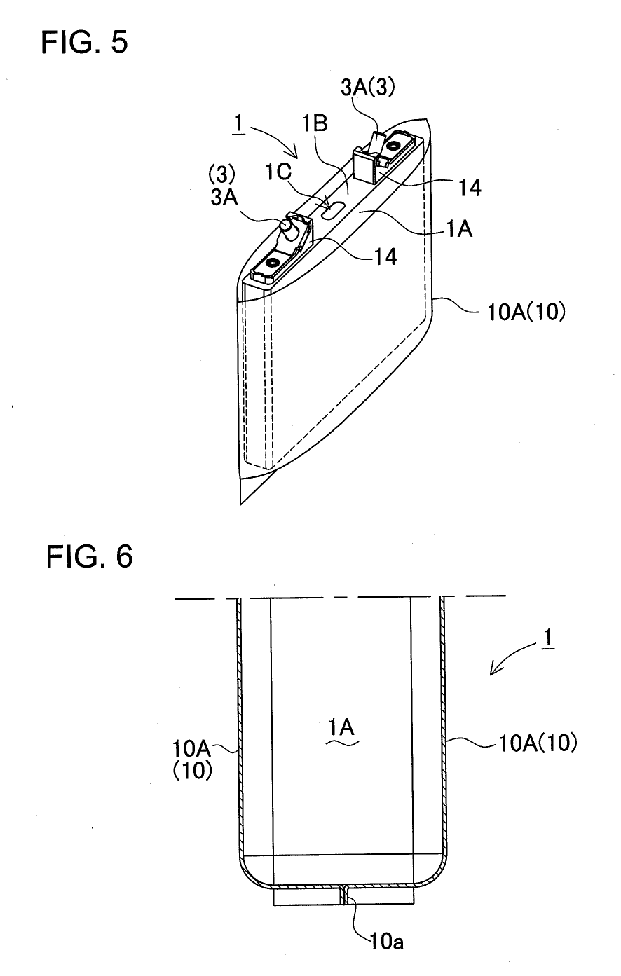

A battery cell 1 with a sheet-metal external case 1A has exposed metal surfaces. As shown in FIG. 5, battery cells 1 are covered with insulating sheet 10, which is heat-shrink tubing 10A. Each battery cell 1 is inserted in cylindrically shaped heat-shrink tubing 10A, the bottom end of the heat-shrink tubing 10A is heat-sealed together at the bottom surface of the battery cell 1, and the heat-shrink tubing 10A is heated to tightly attach it to the surfaces of the battery cell 1. As shown in the enlarged cross-section view of FIG. 6, a battery cell 1 enclosed in insulating sheet 10, which is heat-shrink tubing 10A, has a heat-sealed section 10a protruding from its bottom surface.

(Terminal Holder 14)

Each terminal holder 14 is formed in a triangular shape with an inclined surface, and insulates the section of the battery cell 1 upper surface around the electrode terminal 3 (excluding the electrode terminal 3). The terminal holder 14 is made from an insulating material such as plastic. An electrode terminal 3 is disposed on the inclined surface of each terminal holder 14, and terminal holders 14 are disposed in specified locations at both ends of the upper surface of the battery cell 1 with the electrode terminals 3 protruding outward at oblique angles. Internally, the positive and negative electrode terminals 3 are connected to positive and negative electrode plates (not illustrated).

(Bus-bar 6)

Battery cells 1 have bus-bars 6 connected to the electrode terminals 3. Threaded studs 3A fixed at the electrode terminals 3 are inserted through the bus-bars 6, nuts 12 are threaded onto the studs 3A, and the nuts 12 are tightened onto the electrode terminals 3. Each bus-bar 6 is a metal plate with through-holes opened at each end to insert the threaded studs 3A fixed at the electrode terminals 3 of adjacent battery cells 1. Bus-bars 6 are positioned on, and attached to the electrode terminals 3 to electrically connect adjacent battery cell 1 electrode terminals 3. Bus-bar 6 connections are different depending on whether the battery cells 1 are connected in series or parallel. Specifically, positive electrodes are connected to negative electrodes for series connection, while positive electrodes are connected to positive electrodes and negative electrodes are connected to negative electrodes for parallel connection. The battery array in the figures has the electrode terminals 3 of adjacent battery cells 1 connected by bus-bars 6 to connect the battery cells 1 in series. A battery array with battery cells 1 connected in series can output high voltage. However, the battery array can also have battery cells connected in parallel to increase current capacity.

(Separator 2)

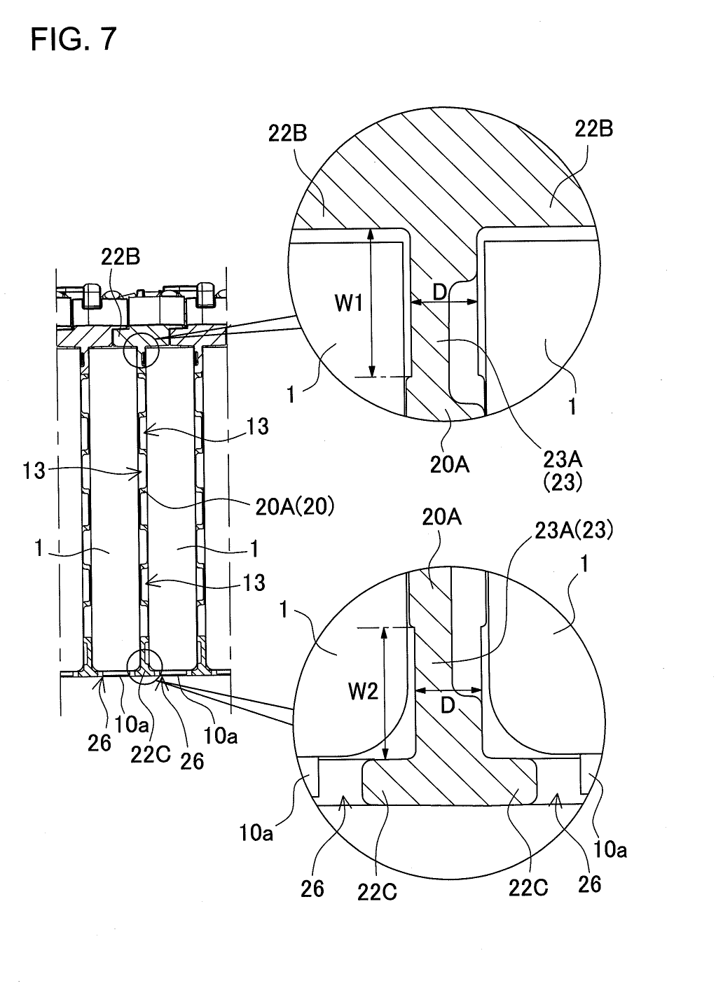

As shown in FIG. 7, separators 2 are sandwiched between adjacent battery cells 1 to insulate adjacent battery cells 1 and maintain a fixed interval between the battery cells 1. Accordingly, separators 2 are constructed from insulating material to insulate the external cases 1A of adjacent battery cells 1. This type of separator 2 is manufactured by molding an insulating material such as plastic. The separators 2 shown in FIG. 7 are provided with cooling gaps 13 on the partition plates 20, which are the parts of the separators 2 inserted between the battery cells 1, to pass cooling gas such as air to cool the battery cells 1. Separators 2 with cooling gaps 13 cool the battery cells 1 by forced ventilation of a cooling gas such as air through the cooling gaps 13. However, it is not always necessary to provide cooling gaps on the separators. This is because (although not illustrated) battery cells can also be cooled by thermally coupling the bottom surfaces of the battery cells with a cooling plate, which is forcibly cooled by a coolant or refrigerant.

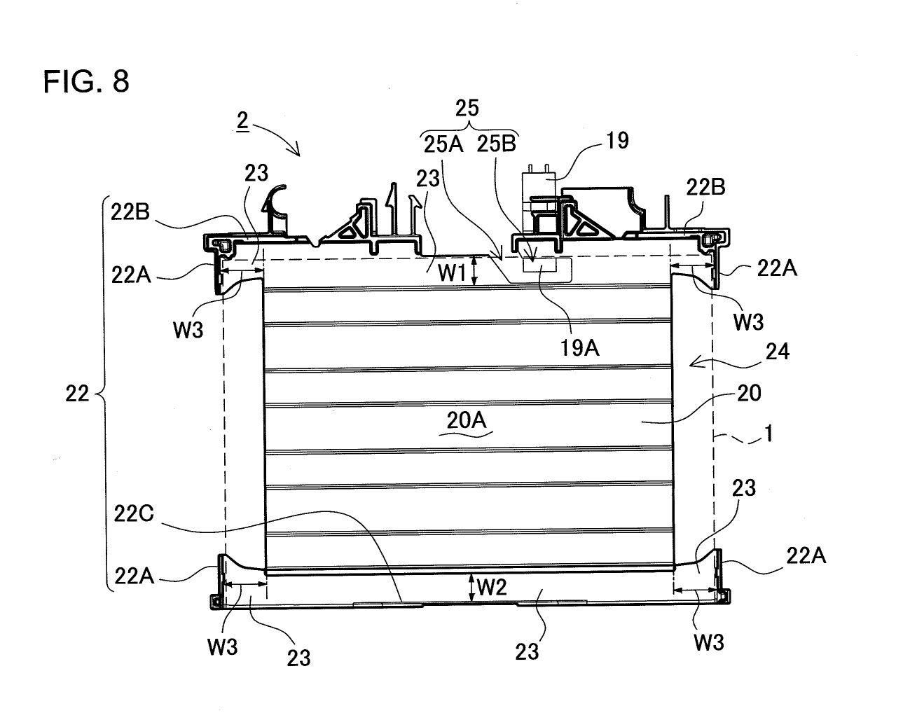

A separator 2 is molded from plastic with a single-piece construction. As shown in FIGS. 4 and 8, a separator 2 is provided with perimeter walls 22 that protrude in the battery cell 1 stacking direction from the perimeter of the partition plate 20, which is the region sandwiched between the battery cells 1.

This type of separator 2 has the interior shape of the perimeter walls 22 essentially equal to the battery cell 1 outline, and battery cells 1 are inserted inside the perimeter walls 22 to dispose the separator 2 and battery cells 1 in fixed relative positions. The perimeter walls 22 are made up of vertical side-walls 22A positioned outside the battery cell 1 side-walls on both sides, upper walls 22B positioned outside the upper surfaces of the battery cells 1, and bottom walls 22C positioned outside the bottom surfaces of the battery cells 1. The bottom walls 22C are established on the bottom surface of the separator 2 and protrude in the battery cell 1 stacking direction, which is in a horizontal direction.

Vertical side-walls 22A at the top of the separator 2 are formed with right-angle connections to the upper walls 22B. Vertical side-walls 22A at the bottom of the separator 2 are formed with right-angle connections to the bottom walls 22C. The vertical side-walls 22A are made with a width that traverses the entire battery cell 1 thickness (battery cell 1 dimension in the stacking direction) on both sides when separators 2 are sandwiched between battery cells 1. Specifically, the amount of side-wall 22A protrusion in the battery cell 1 stacking direction is made equal to half the battery cell 1 thickness to enable the total battery cell 1 thickness to be covered when battery cells 1 and separators 2 are stacked together. The side-walls 22A are not established in a continuous manner from the top to the bottom of a separator 2. Rather, only upper and lower side-wall 22A sections are established, and an open region 24 is provided in between to allow forced ventilation of cooling air between the separator 2 and battery cell 1.

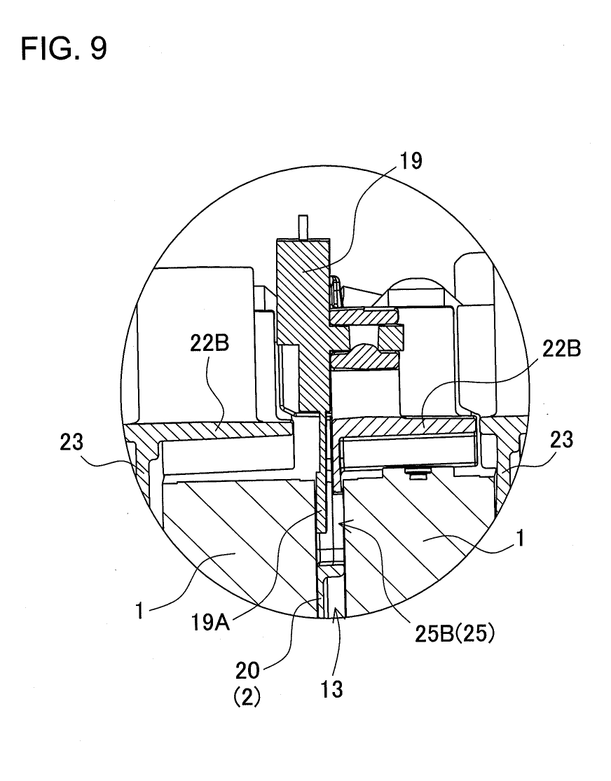

To avoid closing-off battery cell 1 safety valve openings 1C or interfering with electrode terminals 3 established on the upper surfaces of the battery cells 1, separator 2 upper walls 22B have a shape that exposes the electrode terminals 3 and safety valve openings 1C. Further, the separator 2 in FIG. 8 is provided with a sensor cavity 25 in the upper part of the separator 2 below the upper walls 22B to dispose a temperature sensor 19 to detect battery cell 1 temperature. The sensor cavity 25 is provided with an insertion section 25A that opens at an oblique angle with respect to the upper edge of the separator 2, and a retaining section 25B connected with the insertion section 25A and extending in a horizontal direction. A temperature sensor 19 is inserted from the insertion section 25A into the retaining section 25B to dispose the sensing element 19A in the retaining section 25B. As shown in FIG. 9, since the sensor cavity 25 is disposed below the separator 2 upper walls 22B, the sensing element 19A of the temperature sensor 19 is inserted at a given depth below the upper surface of the battery cell 1. Since the retaining section 25B extends in the horizontal direction, a sensing element 19A held in the retaining section 25B is inserted to the same depth below the upper surface of the battery cell 1 regardless of where it is positioned in the retaining section 25B. Consequently, this type of sensor cavity 25 can accurately position temperature sensor 19 sensing elements 19A at the same depth below the top of the battery cells 1.

The separator 2 described above retains a temperature sensor 19 sensing element 19A in a position below the upper surface of the battery cell 1. However, a sensor cavity made up of an insertion section and a retaining section can also retain a temperature sensor sensing element on the upper surface of the battery cell. This type of separator has a retaining section disposed at the upper surface of the battery cell, and the sensing element is held inside the retaining section on the battery cell upper surface.

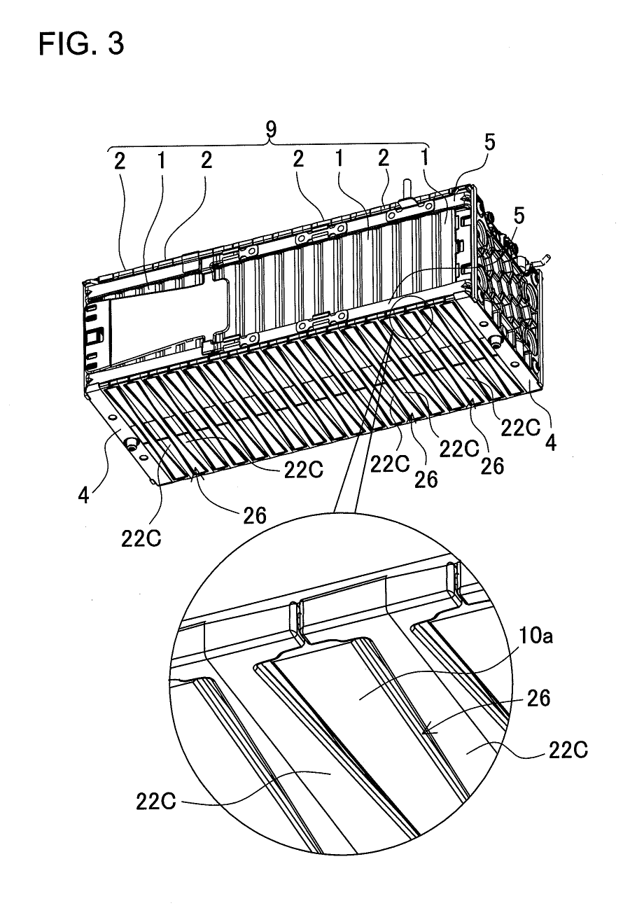

Separator 2 bottom walls 22C have bottom openings 26 established between adjacent separators 2 to retain heat-sealed sections 10a of heat-shrink tubing 10A covering the battery cells 1. When battery cells 1 are sandwiched between adjacent separators 2, the separators 2 hold the heat-shrink tubing 10A heat-sealed sections 10a protruding from the bottom surfaces of the battery cells 1 in the bottom openings 26. The separators 2 shown in the oblique bottom view of the battery array and enlarged inset of FIG. 3 have bottom openings 26 that become wider from the center region towards both sides of the battery array. These separators 2 can dispose the battery cells 1 in designated positions inside the perimeter walls 22 while holding the heat-sealed sections 10a in the bottom openings 26 without pinching heat-shrink tubing 10A in between adjacent separators 2. In particular, a battery cell 1 enclosed in heat-shrink tubing 10A in the manner shown in FIG. 5 forms a heat-sealed section 10a at the bottom surface in a configuration that tends to make both end regions wider than the center region. Accordingly, separators 2 with bottom openings 26 that gradually become wider from the center region towards both ends can reliably align those heat-sealed sections 10a in the bottom openings 26 without pinching heat-shrink tubing 10A in between the separators 2.

A separator 2 has a partition plate 20, which is the part sandwiched between battery cells 1, and the partition plate 20 is provided with a thin region 23 along the section opposite the upper ends of the battery cells 1 that is formed thinner than the partition plate 20 region opposite the center sections of the battery cells 1. As shown in FIG. 8, the separator 2 is preferably provided with thin regions 23 along sections of the partition plate 20 that are opposite the (entire) perimeter of the battery cells 1. Thin regions 23 of partition plates 20 sandwiched between battery cells 1 are shown in FIGS. 7, 10, and 11. However, these figures show conditions when the stack is not compressed by the endplates 4. As shown in these figures, when the stack is not compressed between the endplates 4, thin regions 23 established at the upper ends of the partition plates 20 and along the perimeters of the partition plates 20 are separated from the surfaces of the battery cells 1.

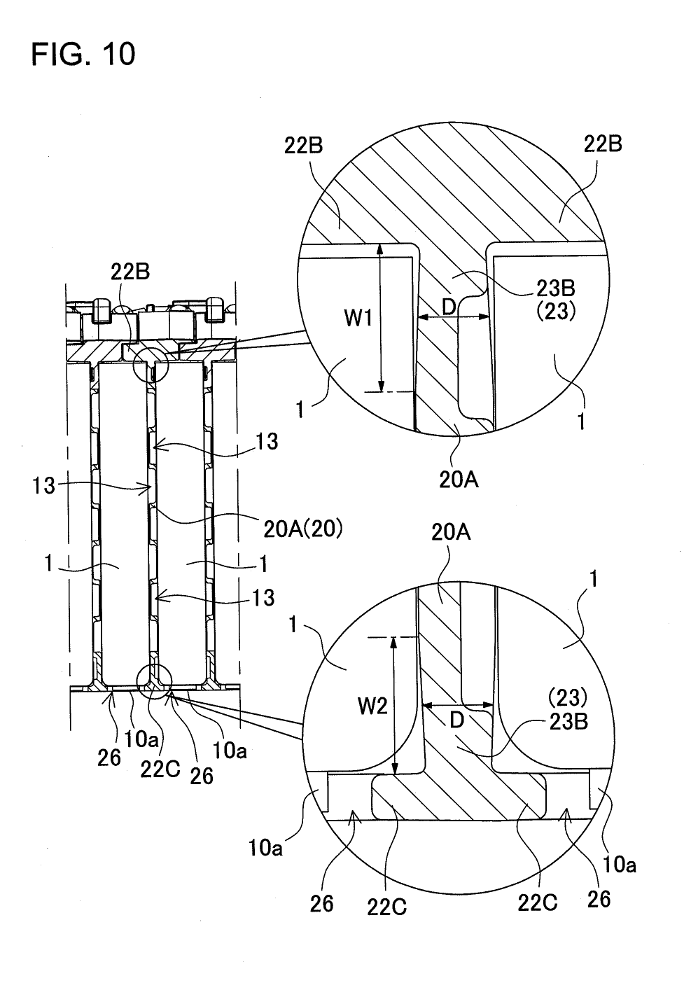

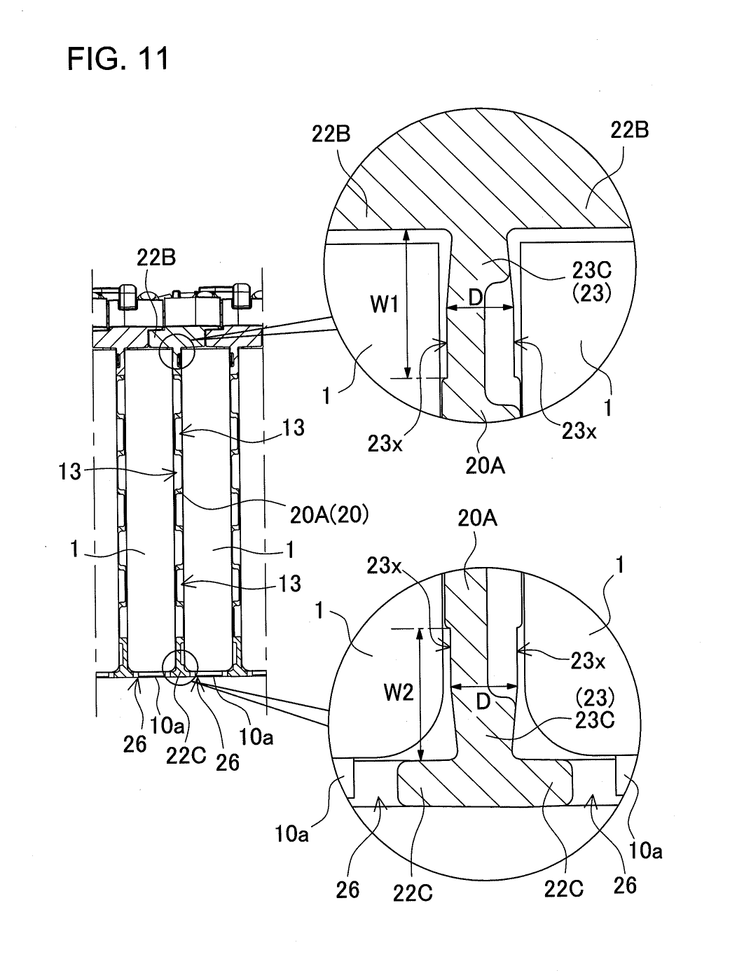

The partition plates 20 in FIG. 7 have steps formed at the boundaries between thin regions 23A and center regions 20A that make the thin regions 23 thinner than the center regions 20A. The boundaries between the thin regions 23A and center regions 20A are formed as curved steps with a given radius of curvature. The partition plates 20 in FIG. 10 have thin regions 23B that are tapered and gradually become thinner towards the battery cell 1 perimeters. Further, the partition plates 20 in FIG. 11 have curved steps with a given radius of curvature formed at the boundaries between thin regions 23C and center regions 20A, and also gradually become thinner from the stepped-down region 23x towards the battery cell 1 perimeters.

As shown in FIG. 8, for a battery cell 1 with a height of 85 mm and width of 120 mm, the partition plate 20 optimally has a thin region 23 width (W1) of approximately 7 mm along the upper end of the battery cell 1, a thin region 23 width (W2) of approximately 6 mm along the bottom of the battery cell 1, a thin region 23 width (W3) of approximately 10 mm along both sides of the battery cell 1, and a thin region 23 thickness (D) that is 0.3 mm thinner than the center regions 20A. However, the widths (W) of the thin regions 23 can be made typically greater than or equal to 2 mm, preferably greater than or equal to 3 mm, and more preferably greater than or equal to 4 mm. In addition, the widths (W) of the thin regions 23 can be made typically less than or equal to 30 mm, preferably less than or equal to 25 mm, and more preferably less than or equal to 20 mm. Further, the difference between the center region 20A thickness the average thickness of the thin regions 23 can be made typically greater than or equal to 0.05 mm, preferably greater than or equal to 0.1 mm, and more preferably greater than or equal to 0.2 mm. In addition, the difference between the center region 20A thickness the average thickness of the thin regions 23 can be made typically less than or equal to 1 mm, preferably less than or equal to 0.8 mm, and more preferably less than or equal to 0.5 mm.

(Endplate 4)

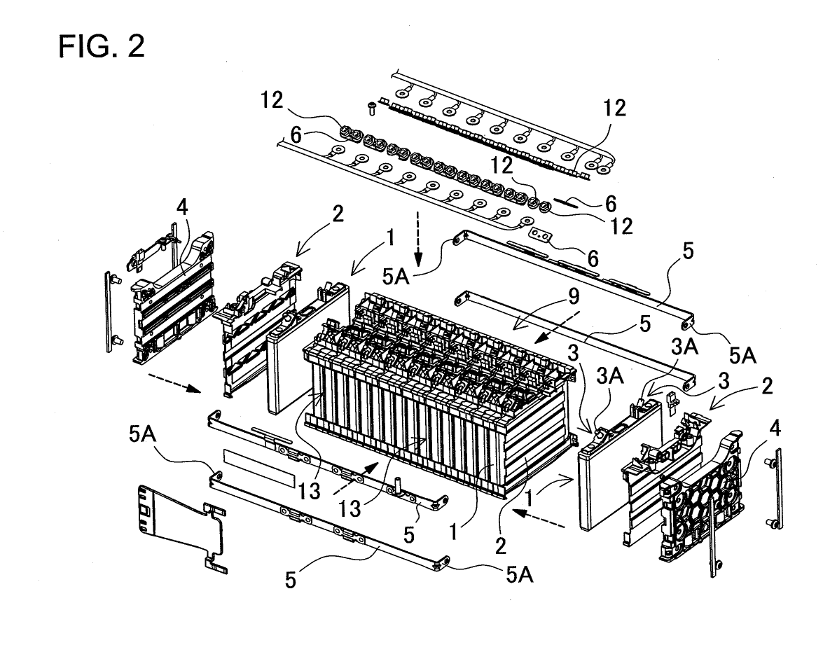

As shown in FIG. 2, a battery block 9, which has battery cells 1 stacked alternately with intervening separators 2, is held together in a compressed state by endplates 4 that press against the separators 2 positioned at both ends of the stack. The endplates 4 are made from hard plastic or a metal such as aluminum or aluminum alloy. To hold the battery cells 1 between the endplates 4 with pressure applied over a wide area, the endplates 4 have essentially the same rectangular outline as the battery cells 1. The rectangular endplates 4 are made the same size as the rectangular battery cells 1 or are made slightly larger than the battery cells 1. Plastic endplates 4 are directly stacked with the battery cells 1 while metal endplates are stacked with intervening insulating material.

(Binding Bar 5)

End regions of the binding bars 5 are attached to the endplates 4. Although the binding bars 5 in FIG. 2 attach to the endplates via set-screws 7, binding bar end regions can also bend inward for endplate attachment, or binding bar end regions can be crimp-attached to the endplates.

The binding bars 5 are made from sheet-metal of a given thickness formed with a given width. The ends of the binding bars 5 connect to the endplates 4 to retain the battery cells 1 in a compressed state between the pair of endplates 4. The binding bars 5 fix the dimension between a pair of endplates 4 to hold the battery cells 1 stacked between the endplates 4 in a given state of compression. If the binding bars 5 stretch due to battery cell 1 expansion pressure, battery cell 1 expansion cannot be prevented. Therefore, the binding bars 5 are made from sheet-metal that will not stretch due to battery cell 1 expansion pressure such as SUS304 stainless-steel sheet-metal or other steel or copper sheet-metal formed with a thickness and width that achieves sufficient strength. The binding bars can also be made by forming sheet-metal in a channel-shape (with a u-shaped cross-section). Since binding bars with this shape have good bending strength, they are characterized by the ability to solidly retain a stack of rectangular battery cells in a given state of compression while making the binding bars narrower. The ends of the binding bars 5 are provided with bent regions 5A, and the bent regions 5A connect to the endplates 4. The bent regions 5A are provided with through-holes for the set-screws 7, and the binding bars 5 are attached to the endplates 4 via set-screws 7 inserted through the through-holes.

The battery array in FIG. 1 has a pair of ventilating ducts 16 established on both the right and left sides. The ventilating ducts 16 are made up of an inlet duct 16A and an exhaust duct 16B established on opposite sides of the battery array. Cooling gas is forced to flow from the inlet duct 16A into the cooling gaps 13 and from the cooling gaps 13 into the exhaust duct 16B to cool the battery cells 1. The inlet duct 16A and exhaust duct 16B are connected through a plurality of parallel disposed cooling gaps 13. Accordingly, cooling gas introduced into the inlet duct 16A divides into the plurality of cooling gaps 13 to flow from the inlet duct 16A to the exhaust duct 16B. Since the inlet duct 16A and exhaust duct 16B are established on the sides of the battery array in the figures, the cooling gaps 13 are established extending in a horizontal direction and cooling gas is forced to flow in a horizontal direction through the cooling gaps 13 to cool the battery cells 1. However, the battery array can also have cooling gaps established extending in the vertical direction, and in that case the pair of ventilating ducts is established on the top and bottom of the battery array.

The battery array described above is used in a power source apparatus carried on-board a vehicle to supply power to a motor that drives the vehicle. A power source apparatus using the battery array described above is provided with a plurality of temperature sensors 19 to detect battery cell 1 temperature, a forced ventilating device 17 that causes cooling gas to flow through the ventilating ducts 16 and all the separate cooling gaps 13 in accordance with battery cell 1 temperature detected by the temperature sensors 19, and a control circuit (not illustrated) that controls battery current depending on battery cell 1 temperature detected by the temperature sensors 19.

The forced ventilating device 17 is connected to the ventilating ducts 16. For example, the power source apparatus can have the forced ventilating device 17 connected to the inlet duct 16A to introduce cooling gas from the forced ventilating device 17 into the inlet duct 16A. In this type of power source apparatus, battery cells 1 are cooled by cooling gas flow as follows: forced ventilating device 17→inlet duct 16A→cooling gaps 13→exhaust duct 16B. However, the forced ventilating device can also be connected to the exhaust duct. In that case the forced ventilating device intakes cooling gas and forcibly discharges it from the exhaust duct. Accordingly, in this type of power source apparatus, battery cells are cooled by cooling gas flow as follows: inlet duct→cooling gaps→exhaust duct→forced ventilating device. Although the cooling gas is air, ventilation can also be implemented by using a relatively inert gas such as nitrogen or carbon dioxide instead of air. In a power source apparatus that uses an inert gas as the cooling gas, battery cells are cooled by circulating the cooling gas. Circulated inert gas is cooled by a heat exchanger disposed at an intermediate point in the circulated cooling gas flow (inlet duct→cooling gaps→exhaust duct→forced ventilating device).

The forced ventilating device 17 is equipped with a fan 17A rotated by a motor with motor operation controlled by a control circuit. The control circuit controls forced ventilating device 17 motor operation according to signals from the temperature sensors 19. If the maximum temperature detected by the temperature sensors 19 exceeds a set temperature, the control circuit turns on the forced ventilating device 17 motor to force cooling gas to flow through the cooling gaps. If the maximum detected temperature drops below the set temperature, motor operation is stopped. The control circuit can also control the amount of power supplied to the motor according to the temperature detected by the temperature sensors 19 to maintain battery cell 1 temperature within a specified range. For example, when the temperature detected by the temperature sensors 19 increases, power supplied to the motor can be gradually increased to increase the amount of ventilation from the forced ventilating device 17. Further, when the detected temperature decreases, power supplied to the motor can be reduced to control battery cell temperature within the set temperature range.

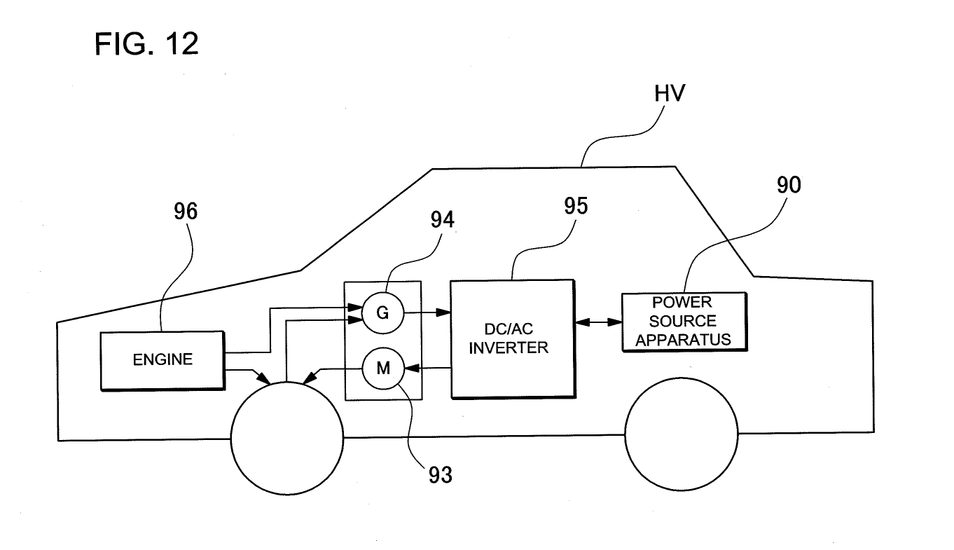

FIG. 12 shows an example of power source apparatus 90 installation on-board a hybrid vehicle, which is driven by both an engine and an electric motor. The vehicle HV equipped with the power source apparatus 90 shown in this figure is provided with an engine 96 and a driving motor 93 to drive the vehicle HV, a power source apparatus 90 equipped with a battery array to supply power to the motor 93, and a generator 94 to charge the battery array batteries. The power source apparatus 90 is connected to the motor 93 and generator 94 via a DC/AC inverter 95. The vehicle HV runs on both the motor 93 and engine 96 while charging and discharging the batteries in the power source apparatus 90. In operating modes where engine efficiency is poor such as during acceleration and low speed cruise, the motor 93 is activated to drive the vehicle. The motor 93 operates on power supplied from the power source apparatus 90. The generator 94 is driven by the engine 96 or by regenerative braking when the vehicle brake pedal is pressed and operates to charge the power source apparatus 90 batteries.

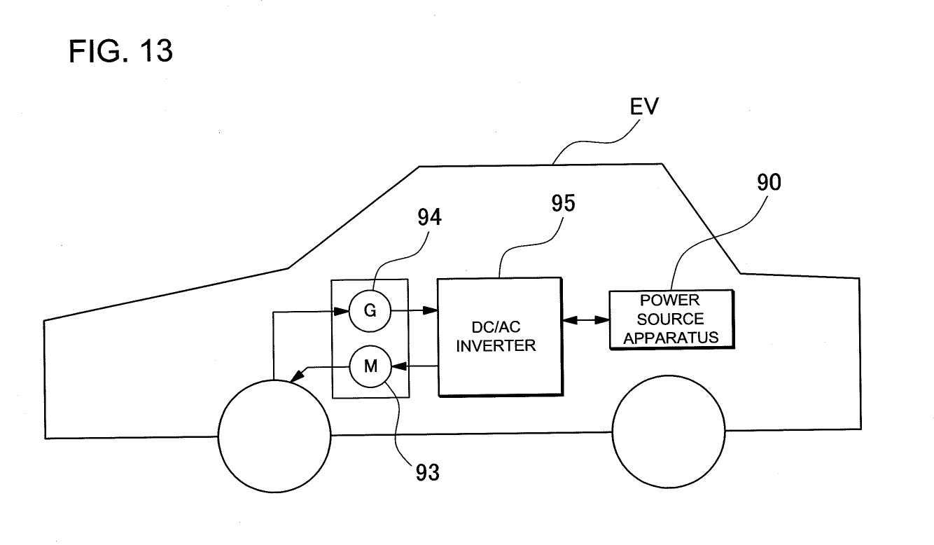

FIG. 13 shows an example of power source apparatus 90 installation on-board an electric vehicle, which is driven by an electric motor only. The vehicle EV equipped with the power source apparatus 90 shown in this figure is provided with a driving motor 93 to drive the vehicle EV, a power source apparatus 90 equipped with a battery array to supply power to the motor 93, and a generator 94 to charge the power source apparatus 90 batteries. The motor 93 operates on power supplied from the power source apparatus 90. The generator 94 is driven by energy from regenerative braking and operates to charge the power source apparatus 90 batteries.

1-13. (canceled)

14. A battery array comprising:
a plurality of battery cells having a rectangular outline;
insulating separators intervening between adjacent battery cells;
a pair of endplates disposed at the ends of battery cells stacked alternately with intervening separators; and
binding bars that bind the endplates together;
wherein partition plates, which are the sections of the separators sandwiched between adjacent battery cells, have thin regions established along partition plate regions opposite the upper ends of the battery cells, and the thin regions are formed thinner than partition plate regions opposite the center sections of the battery cells.

15. The battery array as cited in claim 14, wherein the separators have thin regions established along partition plate regions opposite the perimeters of the battery cells, and the thin regions are formed thinner than partition plate regions opposite the center sections of the battery cells.

16. The battery array as cited in claim 14, wherein boundaries between the thin regions and the center regions of the partition plates are formed in step shapes.

17. The battery array as cited in claim 14, wherein the thin regions are tapered and gradually become thinner towards the outer edges of the battery cells.

18. The battery array as cited in claim 14, wherein the width of the thin regions established on the separator partition plates is made greater than or equal to 2 mm.

19. The battery array as cited in claim 14, wherein the width of the thin regions established on the separator partition plates is made less than or equal to 30 mm

20. The battery array as cited in claim 14, wherein the difference between the average thickness in the thin regions and the thickness in regions opposite battery cell center sections is greater than or equal to 0.05 mm

21. The battery array as cited in claim 14,
wherein the external case of each battery cell is covered with insulating heat-shrink tubing,
wherein the heat-shrink tubing is heat-sealed together at the bottom of the battery cell; each separator has bottom walls, which are flat plates that protrude horizontally from the bottom end of the separator,
wherein the bottom walls establish bottom openings between adjacent separators to retain heat-sealed sections of the heat-shrink tubing, and
wherein when adjacent separators are aligned opposite each other with a battery cell in between, the heat-shrink tubing heat-sealed sections are disposed in the bottom openings.

22. The battery array as cited in claim 14, wherein the top part of a separator is provided with a sensor cavity to dispose a temperature sensor to detect battery cell temperature.

23. The battery array as cited in claim 22, wherein the sensor cavity comprises an insertion section that opens at an oblique angle with respect to the upper edge of the separator, and a retaining section connected with the insertion section and extending in a horizontal direction; and a temperature sensor is inserted from the insertion section into the retaining section to dispose the sensing element in the retaining section.

24. A battery separator that intervenes between adjacent battery cells to insulate the battery cells in a battery array having a plurality of rectangular battery cells stacked together,
wherein a thin region is established along the region opposite the upper ends of the battery cells; and the thin region is formed thinner than the region opposite the center sections of the battery cells.

25. The battery separator as cited in claim 24, wherein thin regions are established along regions opposite the perimeters of the battery cells; and the thin regions are formed thinner than the regions opposite the center sections of the battery cells.

26. A vehicle equipped with the battery array as cited in claim 14.
